(19) United States
(12) Patent Application Publication
(10) Pub. No.: US 2011/0036845 A1
(43) Pub. Date: Feb. 17, 2011

(54) CONTAINER COMPRISING AN INNER LINING, A METHOD OF APPLYING SUCH A LINING TO A CONTAINER AND USE OF A PEEL-ABLE COATING AS AN INNER LINING IN A CONTAINER

(75) Inventor: Benny E. Nielsen, Kalundborg (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Superfos A/S

(21) Appl. No.: 12/736,008

(22) PCT Filed: Jul. 11, 2008
(86) PCT No.: PCT/EP2008/059114

§ 371 Date: Oct. 19, 2010

(30) Foreign Application Priority Data
Mar. 3, 2008 (EP) 08152201.3

(51) Int. Cl. B65D 25/14; B05D 7/22; B05D 3/14; B05D 3/12

(52) U.S. Cl. 220/495.01; 427/230; 427/236; 427/231; 427/534

(57) ABSTRACT

The invention relates to a container (1) for holding fluid or particle compositions which container (1) comprises an inner lining (6) applied to an inner side (2) of the container (1), where the container (1) is provided with an inner lining (6) of a peel-able coating. The peel-able coating can be applied as water based, as Acetone based emulsion or as UV curable lacquer. The invention relates further to a method of manufacturing such a container (1), where the lining (6) is applied to the container (1) by following process steps: Applying a peel-able coating to the inner side of the container (1); Curing and/or drying the peel-able coating by heating, blowing or radiating by UV-light. Further the invention relates to the use of a peel-able coating as an inner lining (6) in a container (1) for fluid materials, such as paint or other materials able to leave residues on or in the container.

The invention relates to a container for holding fluid or particle compositions, which container comprises an inner lining applied to an inner side of the container.

The invention also relates to a method of manufacturing a container for holding fluid or particle compositions, which container comprises an inner lining applied to an inner side of the container.

The invention further relates to the use of a peel-able coating as an inner lining in a container for fluid or particle materials.

In several years containers i.e. for containing paint have been thrown away after use.

As more and more of the materials kept or stored in such containers are categorised as being possibly damaging the environment, the containers must not be thrown away in normal waste management.

It is therefore desirable to make it possible to separate remaining content from the container itself.

Only the residue needs to be disposed of as dangerous goods. The container can be recycled i.e. as plastic scrap.

It is known to produce containers with a kind of lining where it is possible to remove the lining after use and thereby achieve a clean container without any hardened or fluent materials remaining on the inner side of the container.

Such a solution is known from U.S. Pat. No. 6,679,398 B where a paint container liner system is described. The paint container liner system includes disposable liners and an open container for receiving at least one of the disposable liners. The liners are sized and configured to fit into the inside of the container and around the rim of the container. The liners are maintained in position in the container by a suction generated during installation, by a non curing adhesive interposed between the liner and the container, by the liners being stretched around the rim of the container or configured with a rounded bottom to retain the liner in place during use.

From U.S. Pat. No. 5,492,242 A is known that paint buckets and other sales packaging for paints, solvents and the like must be cleaned from contamination by residual amounts of the previous content before a reuse. Such a container is provided with protective layers which are applied to its container walls in several layers, which protective layers are separated by separating layers and which protective layers, starting from a detaching point, can be pulled off together with adhering contaminations so that the container can be reused again without any cleaning expenditures.

A problem with these known containers with liners is that when paint is sold it is most often stored at the shop in a basis colour and intended to be mixed into a colour selected by a customer.

When a colour is selected and a necessary amount of colour pigment is applied, the container is exposed to an excessive shaking in a shaking machine. When exposing a container relating to prior art to such an excessive shaking, it is very likely that the protective layer(s) will detach from the inner side of the container.

When the customer at a later time is going to use the paint it is necessary to perform a mixing or stirring to make sure that the colour is fully blended and thereby has obtained the correct colour.

If the protective layer has been detached from the inner side of the container, it is very difficult to perform a sufficient mixing of the paint.

### New Technique

A solution to this problem is to provide a protective layer, easy to apply to the container and easy to remove from the container after use, which layer will not detach during excessive shaking of the container.

This is achieved according to the invention in that the container is provided with an inner lining of a peel-able coating.

An advantage achieved by applying such a protective peel-able coating or layer to a container is that when the container is emptied residues are normally remaining on the inner side of such a container. By applying the protective peel-able layer to the inner side of the container before filling, it is possible to remove the protective layer in one piece covering the inner side of the container, the piece now forming a kind of bag being able to enclose the residues. When the protective layer is removed from the container, the residues together with the peel-able protective layer can be disposed of as dangerous goods if necessary, and the container can be used again or recycled i.e. as plastic scrap.

It is important that the peel-able layer does not disintegrate when peeled off, the container thereby being able to contain the residues left on the inner side of the layer.

The peel-able layer can be removed by hand or by a suitable tool, the tool being operated by hand or automatically.

The tool can be a removable tap placed on the upper edge of the container.

In further embodiments the peel-able coating is applied as water based or Acetone based emulsion.

In another embodiment the coating is cured by UV light.

In yet further embodiments the peel-able coating is applied as water based (e.g. Acrylic), Acetone (e.g. PVC) based emulsion or as a UV curable lacquer.

In another embodiment according to the invention the thickness of the lining is in the range from 50-400 μm, alternatively 50-300 μm.

Hereby it is achieved that it is possible to stack the containers after applying the inner lining without significantly increasing the stacking height.

To ensure a sufficient adherence to the container whether the container is just ready from the mould or if it is a previously produced “standard” container originally intended for a completely other purpose or even if the container is a used container, the container is provided in a further embodiment with a roughened surface on the inner side of the container.

In yet an embodiment the roughened surface is applied only on the side of the container and not to the bottom.

A solution to the above problem is also achieved by a method where the lining is applied to the container by following process steps:
Applying a peel-able coating to the inner side of the container;
Curing and/or drying the peel-able coating by heating, blowing or radiating by UV-light.

In another embodiment the inner side of the container is roughened by blasting from particles.

In other embodiments of the method the peel-able coating is applied by spraying, by a roller or by spinning or rotating the container.

In further an embodiment the inner side of the container is roughened by blasting of sand or glass particles or by corona or flame treatment.

In another embodiment the lining is applied directly after the container is moulded.

This gives the possibility to apply the lining when the position of the container is well determined and unnecessary movement is reduced.

In yet an embodiment the lining is applied to a container being a previously produced container.

In further an embodiment the containers are stacked shortly after applying the inner lining.

This reduces intermediate storing space and unnecessary movement of the containers.

A solution of the problem is also achieved by the use of a peel-able coating as an inner lining in a container for fluid or particle materials, such as paint or other materials able to leave residues on or in the container.

In a further embodiment the peel-able coating or layer also is applied around the upper edge of the container and to the outside of a round going skirt extending downwards from the upper end of the outside of the container.

Embodiments will now be discussed in further detail with reference to the accompanying drawing in which:

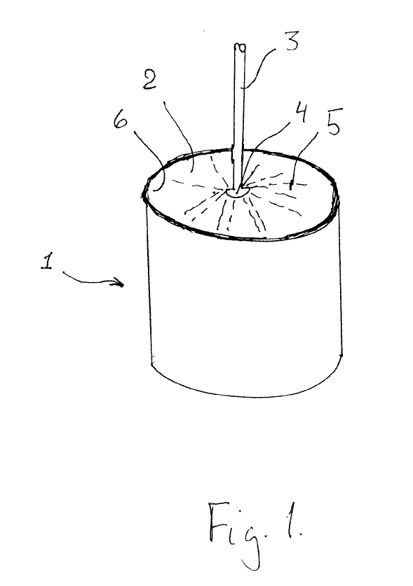

FIG. 1 schematically shows a container being provided with a protective layer, and

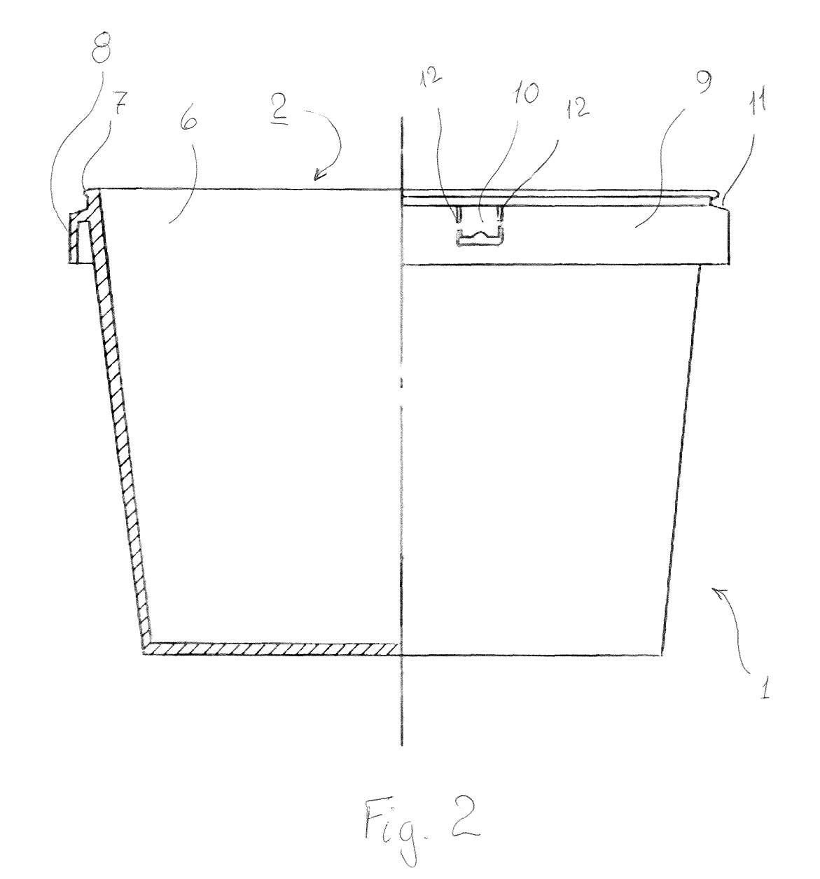

FIG. 2 schematically shows a container with a left side cut away and a right side provided with a lid.

The drawing in principle shows how a container 1 is provided with a protective layer 6 according to an embodiment of the invention. The invention is not limited to a single embodiment, but comprises further embodiments derived from the specification.

These objectives can be achieved by applying a peel-able film or layer 6 on the inside surface 2 of a container 1. The film or layer 6 is applied to the container 1 before filling with paint or other fluids. When the container 1 is emptied from paint or other fluids, it is possible to remove the residue by peeling off the film or layer 6. When peeled, the film or layer 6 turns into a bag containing the paint or other fluid residue and thus leaving the container 1 clean from paint or other fluid.

A peel-able coating shows remarkably good properties to be used in combination with such a container 1, which is mostly produced in a kind of plastics.

In an embodiment of the invention the peel-able coating is applied as water based or Acetone based emulsion.

In another embodiment the coating is cured by UV light.

In yet further embodiments the peel-able coating is applied as water based (e.g. Acrylic) or Acetone (e.g. PVC) based emulsion or as a UV curable lacquer.

These are commercially available products, but intended for completely other applications.

Once applied, the peel-able coating dries into a solid film or layer 6 and after curing the surface is resistant to paint.

To speed up the drying process, curing can be provided by drying and/or heating by blowing a gas, such as air, at a temperature selected according to the desired curing time into the container.

Curing can also be provided by radiation from one or more UV light sources.

To ensure in an embodiment a further adherence to the container whether the container 1 is just ready from the mould or if it is a previously produced “standard” container originally intended for a completely other purpose or even if the container 1 is a used container, the container 1 is provided in a further embodiment with a roughened surface on the inner side 2 of the container 1. The roughened surface on the inner side 2 of the container 1 is provided by particle blasting or by corona or flame treatment.

Suitable particles for the blasting are sand or glass particles, but other small hard particles can be used as well as long as they are suitable for roughening the surface of the container.

The peel-able coating or layer will then have a sufficient weak adherence to the plastic container to be peeled off after use but an adherence strong enough to stay in place during filling, transport and tinting/shaking.

When the peel-able coating is applied, which application can be performed by spraying, rolling, by pouring a sufficient amount of peel-able coating into the container and following spin or rotate the container in such a way, that the peel-able coating will be applied to all over the inner side of the container. How long the spinning or rotating period should be, depends on the temperature and on the desired thickness of the protective layer.

FIG. 1 shows a simple way to apply the peel-able coating by a nozzle 4 at a supply tube 3, which nozzle 4 produces a spray 5 and thereby applies a protective film or layer 6 in form of a lining on the inner side 2 of the container 1.

When the peel-able coating is applied, a curing of the applied layer can be performed.

Again the curing period depends on other parameters as well as on the curing method.

The protective and peel-able layer protects the container from paint or like fluids or particle materials to residue on the inner side of the container.

Applying such a layer to the container makes it possible to produce the container from a less expensive material. The protective layer also can provide barrier means preventing compositions aggressive to the material used for the container to come into contact with the container wall. An example can be protection of the container to solvent based liquids.

A further advantage to the invention is that the layer applied to the container is a relatively thin layer. Normally the thickness of the layer will be in the range from 50-400 μm, alternatively 50-300 μm.

Having such a thin layer makes it possible to stack the containers.

Hereby is achieved an adherence to the plastic surface weak enough to allow easy removal of the film or layer and a film or layer itself strong enough to stay in one piece when removed from the container, acting as a bag containing the paint residue.

In another embodiment the lining is applied directly after the container is moulded.

This makes it possible to apply the lining when the position of the container is well determined and unnecessary movement is reduced.

In yet an embodiment the lining is applied to container being a previously produced container, giving the possibility to make use of other containers or even previously used containers.

In further an embodiment the containers are stacked shortly after applying the inner lining which also reduces unnecessary movement or handling of the containers.

In a further embodiment the peel-able coating 6, 9 also is applied around the upper edge 7 of the container 1 and to the outside of a round going skirt 8 extending downwards from the upper end of the outside of the container 1.

The upper edge of the container 1 is on the outside provided with a bead or ridge 7 intended to snap into a corresponding groove in a lid, which lid (not shown) when applied will abut an upper shoulder 11 of the round going skirt 8.

The peel-able coating 6, 9 applied to the area around the bead or ridge 7 will provide a further sealing between the container 1 and the lid compared to a situation where no peel-able coating is applied.

When the peel-able coating 6, 9 is applied to the inner side of the container and as well on the outside of the upper edge 7 it is possible to avoid contamination by residual amounts of the previous content before a reuse of the container 1.

To make it easier to remove (peel off) the peel-able layer a removable tap 10 is provided in the round going skirt 8. The removable tap 10 is in a transition area between the body or middle portion of the tap 10 and the round going skirt 8 provided with a weakening line or a number of connection points 12 to be broken when tearing off the removable tap 10.

When tearing off the removable tap 10, the peel-able layer 6, 9 attached to the tap 10 will detach from the round going skirt 8 and from the inner side 2 of the container 1. Hereby it is possible to remove the peel-able layer 6, 9 in an easy and effective manner without tearing the peel-able layer 6, 9 apart and thereby be sure that the residues from paint or the like is held inside the kind of bag provided by the peeled off peel-able layer.

The peel-able layer 6, 9 can be applied around the upper edge of the container 1 by spraying or by a roller. The container can be fixed in a template which abuts the underside of the round going skirt 8, preventing the peel-able layer from being applied to the rest of the outer side of the container 1.

The container 1 can be held in a not rotating position or it can be rotated during applying the peel-able coating 6, 9.

In a further embodiment of the container 1, the outer side of the round going skirt 8 can be provided with a roughened surface.

In the above the container is mainly described as a container for containing paint, but it is obvious that it is possible to use the invention in relation to other materials able to leave residues on or in the container.

The invention also applies to the use of a peel-able coating as an inner lining in a container for fluid or particle materials, such as paint or other materials able to leave residues on or in the container.

The invention is not limited to the use of the mentioned peel-able coating since any suitable peel-able coatings can be used as long as they fulfil the properties described herein.

1. A container for holding fluid or particle compositions, which container comprises an inner lining applied to an inner side of the container, characterized in that the container (1) is provided with an inner lining (6) of a peel-able coating.

2. A container according to claim 1, characterized in that the peel-able coating is applied as water based emulsion.

3. A container according to claim 1, characterized in that the peel-able coating is applied as Acetone based emulsion.

4. A container according to claim 1, characterized in that the peel-able coating is applied as a UV curable lacquer.

5. A container according to one or more of the claims 1-4, characterized in that the thickness of the lining (6) is in the range from 50-400 μm.

6. A container according to one or more of the claim 1, 2, 3, 4 or 5, characterized in that the inner side (2) of the container (1) comprises a roughened surface.

7. A container according to one or more of the claims 1-6, characterized in that the peel-able coating (6, 9) also is applied around the upper edge (7) of the container (1) and to the outside of a round going skirt (8) extending downwards from the upper end of the outside of the container (1).

8. A container according to claim 7, characterized in that a removable tap (10) is provided in the round going skirt (8).

9. A container according to claim 8, characterized in that the removable tap (10) in a transition area between the body or middle portion of the tap (10) and the round going skirt (8) is provided with a weakening line or a number of connection points (12) to be broken when tearing off the removable tap (10).

10. A container according to one or more of the claims 7-9, characterized in that the outer side of the round going skirt (8) comprises a roughened surface.

11. Method of manufacturing a container for holding fluid or particle compositions, which container comprises an inner lining applied to an inner side of the container, characterized in that the lining (6) is applied to the container (1) by following process steps:
Applying a peel-able coating (6, 9) to the inner side (2) of the container (1);
Curing and/or drying the peel-able coating by heating, blowing or radiating by UV-light.

12. Method according to claim 11, characterized in that the peel-able coating (6, 9) also is applied around the upper edge (7) of the container (1) and to the outside of a round going skirt (8) extending downwards from the upper end of the outside of the container (1).

13. Method according to claim 11 or 12, characterized in that the inner side (2) of the container (1) and/or the upper edge (7) of the container (1) and the outside of the round going skirt (8) extending downwards from the upper end of the outside of the container (1) is roughened by blasting from particles.

14. Method according to one or more of the claims 11-13, characterized in that the peel-able coating (6, 9) is applied by spraying.

15. Method according to one or more of the claims 11-13, characterized in that the peel-able coating (6, 9) is applied by a roller.

16. Method according to one or more of the claims 11-13, characterized in that the peel-able coating (6, 9) is applied by spinning or rotating the container (1).

17. Method according to claim 13, characterized in that the inner side (2) of the container (1) and/or the upper edge (7) of the container (1) and the outside of the round going skirt (8) extending downwards from the upper end of the outside of the container (1) is roughened by blasting of sand or glass particles or by corona or flame treatment.

18. Method according to one or more of the claims 11-17, characterized in that the lining in form of the peel-able coating (6, 9) is applied directly after the container (1) is moulded.

19. Method according to one or more of the claims 11-17, characterized in that the lining (6) is applied to the container (1) being a previously produced container.

20. Method according to one or more of the claims 11-19, characterized in that the containers (1) are stacked shortly after applying the inner lining (6) or peel-able coating (6, 9).

21. Use of a peel-able coating (6, 9) as an inner lining (6) in a container (1) for fluid or particle materials, such as paint or other materials able to leave residues on or in the container.
